(19) United States
(12) Patent Application Publication
(10) Pub. No.: US 2026/0148013 A1
(43) Pub. Date: May 28, 2026

(54) INFORMATION PROCESSING SYSTEM, INFORMATION PROCESSING METHOD, AND NON-TRANSITORY COMPUTER-READABLE MEDIUM STORING PROGRAM CODE

(71) Applicant: Rakuten Group, Inc., Tokyo (JP)

(72) Inventors: Shun OYAMA, Tokyo (JP); Sumedhan RAMESH, Tokyo (JP); Luis ORELLANA, Tokyo (JP); I-Tzu CHEN, Tokyo (JP); Paul DARGAN, Tokyo (JP)

(73) Assignee: Rakuten Group, Inc., Tokyo (JP)

(21) Appl. No.: 19/280,319

(22) Filed: Jul. 25, 2025

(30) Foreign Application Priority Data
Nov. 27, 2024 (JP) 2024-206283

(51) Int. Cl. G06F 40/40

(52) U.S. Cl. CPC G06F 40/40

(57) ABSTRACT

An information processing system that includes one or more memories configured to store program code and one or more processors. The one or more processors are configured to read the program code and operate as instructed by the program code. The program code includes first prompt generation code configured to cause at least one of the one or more processors to generate a first prompt that includes a source text, an edited text obtained by editing the source text, and an instruction for determining an editing error in the edited text in association with an error category. The program code includes error acquisition code configured to cause at least one of the one or more processors to acquire the editing error in correspondence with the error category by inputting the first prompt into a language model.

### CROSS-REFERENCE TO RELATED APPLICATIONS

This application is based upon and claims the benefit of priority from Japanese Patent Application No. 2024-206283, filed on Nov. 27, 2024, the entire contents of which are incorporated herein by reference.

### BACKGROUND

### 1. Field

The present disclosure relates to an information processing system, an information processing method, and a non-transitory computer-readable medium storing program code.

### 2. Description of Related Art

Japanese Laid-Open Patent Publication No. 2023-169844 discloses an example of an information processing system in which a translation result generated by a learning model is evaluated by an evaluator and the evaluation result is then input by the evaluator. Such an information processing system allows the learning model to be evaluated based on the evaluation of the translation result, which is an example of an editing output.

However, in the information processing system, an evaluator determines whether the editing output is valid and then manually inputs the evaluation result. This imposes a burden on the evaluator. Thus, there is a need for improving the convenience in evaluating the edit accuracy.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An information processing system according to an aspect of the present disclosure includes one or more memories configured to store program code and one or more processors. The one or more processors are configured to read the program code and operate as instructed by the program code. The program code includes first prompt generation code configured to cause at least one of the one or more processors to generate a first prompt that includes a source text, an edited text obtained by editing the source text, and an instruction for determining an editing error in the edited text in association with an error category. The program code includes error acquisition code configured to cause at least one of the one or more processors to acquire the editing error in correspondence with the error category by inputting the first prompt into a language model.

An information processing method according to an aspect of the present disclosure includes causing one or more processors to generate a first prompt that includes a source text, an edited text obtained by editing the source text, and an instruction for determining an editing error in the edited text in association with an error category. The information processing method includes causing the one or more processors to acquire the editing error in correspondence with the error category by inputting the first prompt into a language model.

A non-transitory computer-readable medium according to an aspect of the present disclosure stores program code. The program code includes first prompt generation code configured to cause one or more processors to generate a first prompt that includes a source text, an edited text obtained by editing the source text, and an instruction for determining an editing error in the edited text in association with an error category The program code includes error acquisition code configured to cause the one or more processors to acquire the editing error in correspondence with the error category by inputting the first prompt into a language model.

Other features and aspects will be apparent from the following detailed description, the drawings, and the claims.

### BRIEF DESCRIPTION OF THE DRAWINGS

FIG. 1 is a diagram illustrating an overall configuration of an information processing system according to an embodiment.

FIG. 2 is a table illustrating a source text dataset included in an error management database in the embodiment.

FIG. 3 is a table illustrating an error dataset included in an error management database in the embodiment.

FIG. 4 is a table illustrating a coefficient database in the embodiment.

FIG. 5 is a flowchart illustrating a source text translation process of the embodiment.

FIG. 6 is a flowchart illustrating a translated text analysis process of the embodiment.

FIG. 7 is a flowchart illustrating an error determination process of the embodiment.

FIG. 8 is a flowchart illustrating an error categorization process of the embodiment.

FIG. 9 is a flowchart illustrating a severity control process of the embodiment.

FIG. 10 is a flowchart illustrating an evaluation control process of the embodiment.

FIG. 11 is a flowchart illustrating a display control process of the embodiment.

FIG. 12 is a first image displayed on the display device of the embodiment.

FIG. 13 is a second image displayed on the display device of the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

An information processing system, an information processing method, and a non-transitory computer-readable medium storing program code according to an embodiment will now be described.

### Configuration of Information Processing System 10

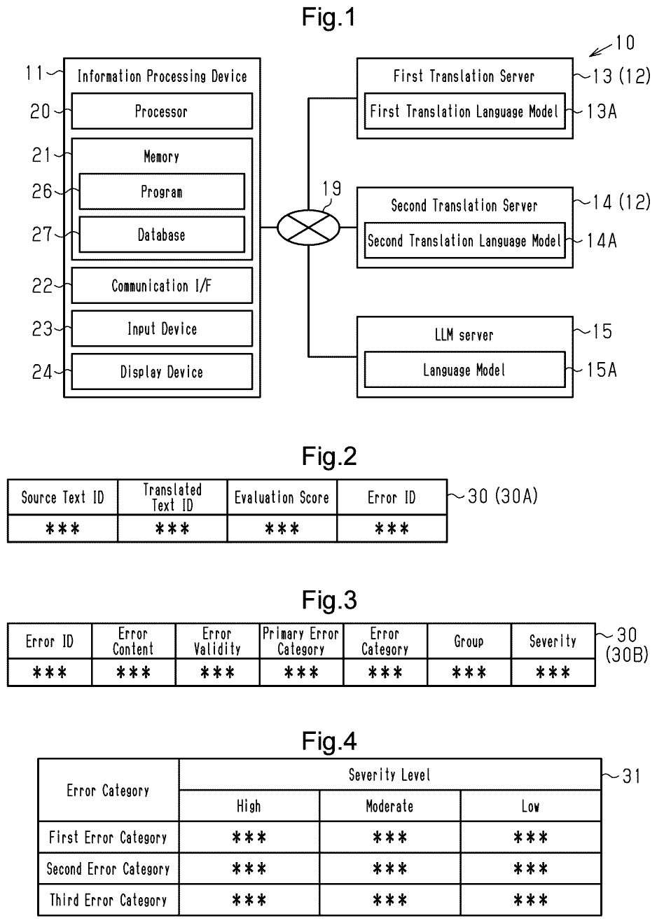

Referring to FIG. 1, the information processing system 10 analyzes the translation accuracy of a translated text. The translated text is obtained by translating a source text written from a first language into a second language. In other words, the translated text is an edited text obtained by editing a source text or is a modified text obtained by modifying a source text. For example, the first language may be Japanese, and the second language may be English. For example, the first language may be English, and the second language may be Japanese. The information processing system 10 may acquire a translated text from a source text.

A source text includes at least one sentence and may include multiple sentences. For example, a source text may be a description in electronic commerce services. For example, a source text may be a description in travel services.

The information processing system 10 includes an information processing device 11. The information processing device 11 acquires a translated text. The information processing device 11 acquires translation errors in a translated text. The information processing device 11 analyzes a translated text. The information processing device 11 evaluates a translated text. The information processing device 11 displays an image related to translation errors.

The information processing system 10 may include at least one translation server 12. The translation server 12 may be used to translate a source text that has been input. The information processing system 10 may include a first translation server 13 and a second translation server 14.

The first translation server 13 may include a first translation language model 13A. The first translation language model 13A is used to translate a source text. The first translation language model 13A may be a machine translation model that translates a source text. The first translation language model 13A corresponds to an example of a first machine translation model. The translated text obtained by translating a source text with the first translation language model 13A corresponds to an example of a first translated text.

The second translation server 14 may include a second translation language model 14A. The second translation language model 14A is used to translate a source text. The second translation language model 14A may be a machine translation model that translates a source text. The second translation language model 14A corresponds to an example of a second machine translation model. The translated text obtained by translating a source text with the second translation language model 14A corresponds to an example of a second translated text.

The information processing system 10 may include a large language model (LLM) server 15. The LLM server 15 may include a LLM 15A. The LLM 15A is built using large-scale data and deep learning techniques. The LLM server 15A functions to control various texts using generative artificial intelligence (AI). The LLM server 15A functions to control various images using generative AI. The LLM server 15A includes various learning models of generative AI.

For example, the LLM server 15 functions to detect translation errors based on a source text and translated text that have been input. The LLM server 15 functions to generate the result of analyzing translation errors. The analysis of translation errors may contain the error category of translation errors, the determination of whether translation errors are valid, and the content related to the severity of translation errors.

The information processing device 11, the translation server 12, and the LLM server 15 may be configured to communicate with each other via a network 19. Hereinafter, the communication via the network 19 between the information processing device 11, the translation server 12, and the LLM server 15 will not be described.

### Configuration of Information Processing Device 11

The information processing device 11 may include at least one computer. The information processing device 11 includes at least one processor 20 and at least one memory 21. The information processing device 11 includes a communication interface 22. In the diagram, the interface is indicated as I/F. The information processing device 11 may include an input device 23 and a display device 24.

The processor 20 controls the information processing device 11. The processor 20 is configured to execute processing based on a program 26 stored in the memory 21. The processor 20 may be a central processing unit (CPU), a graphic processing unit (GPU), or a neural network processing unit (NPU). The processor 20 may include an integrated circuit, such as an application-specific integrated circuit (ASIC), or may be an integrated circuit. The processor 20 may be a combination thereof.

The memory 21 is configured to store the program 26. The memory 21 is a non-transitory computer-readable medium that stores the program 26, and may include a transitory computer-readable medium. The program 26 may include a dedicated application for using the information processing system 10. The memory 21 stores a database 27.

The communication interface 22 is implemented as hardware, software, or a combination thereof. The communication interface 22 sends and receives data to and from the translation server 12 and the LLM server 15.

The input device 23 inputs data in response to the user's operation. The input device 23 may be a touch panel integrated with the display device 24. The input device 23 may be a pointing device having operation buttons. The display device 24 displays information in accordance with output instructions from the processor 20.

The translation server 12 has the same configuration as the information processing device 11. Accordingly, the processor, the memory, and the communication interface of the translation server 12 will not be described. The LLM server 15 has the same configuration as the information processing device 11. Accordingly, the processor, the memory, and the communication interface of the LLM server 15 will not be described.

### Data Configuration of Database 27

As shown in FIGS. 2 and 3, the memory 21 of the information processing device 11 stores an error management database 30 as the database 27. The database 27 includes the error management database 30. The error management database 30 is used to manage translation errors.

The error management database 30 includes at least one source text dataset 30A. In the dataset 30A, a translated text identifier and an evaluation score are associated with one source text identifier. In FIGS. 2 and 3, identifiers are indicated as IDs. In the dataset 30A, at least one error identifier is associated with a source text identifier. The error management database 30 may include at least one error dataset 30B. In the dataset 30B, error content, error validity, primary category (primary error category), error category, group, and severity are associated with one error identifier. In the dataset 30B, at least one error category is associated with an error identifier.

The source text identifier refers to data used to identify a source text. The translated text identifier refers to data used to identify a translated text obtained by translating a source text. The evaluation score refers to data that indicates the result of evaluating a translated text. The evaluation score refers to a value that indicates the degree of a translation error. The evaluation score may increase as the number of translation errors increases. That is, a smaller evaluation score is considered to indicate higher translation accuracy.

The error identifier refers to data used to identify translation errors. The error content refers to data that indicates the content of translation errors. The error validity refers to data indicating the result of determining that translation errors have occurred from a translated text and then re-determining whether the translation errors are valid.

The primary category refers to data indicating a primary category for translation errors. The error category refers to data that indicates an error category for translation errors. The primary category is a valid error category included in at least one error category.

Specifically, the error category may include a first error category, a second error category, and a third error category. The error category may contain, for example, accuracy, fluency, and style.

The error category may be divided into multiple stages. The error category may include major categories and subcategories. The major categories of error category may contain, for example, accuracy, fluency, and style. The subcategories of accuracy may include mistranslation and omission.

The group refers to data that indicates a group related to the error content of translation errors. The group is different from the error category. Multiple translation errors with overlapping error content are grouped into the same group.

The severity refers to data that indicates the severity of translation errors. The severity may include high, moderate, and low levels. The high-level severity includes, for example, a translation error that significantly affects users. The low-level severity may include translation errors that do not alter the intended meaning but degrade the fluency or naturalness of the translation.

In this manner, in the error management database 30, the evaluation scores for translated texts and the data related to translation errors are managed. Specifically, in the error management database 30, the result of detecting at least one translation error from the translated text is used to manage the analysis results of the translation error and the evaluation results of a translated text.

As shown in FIG. 4, the memory 21 of the information processing device 11 stores a coefficient database 31 as the database 27. The database 27 includes the coefficient database 31. The coefficient database 31 is related to coefficients used to calculate evaluation scores for translation errors.

In the coefficient database 31, a combination of primary error categories and severity is associated with coefficients. The evaluation score for a translated text is calculated based on the result of calculating the number of translation errors corresponding to a combination of the primary category and severity and calculating a coefficient corresponding to a combination of the primary category and severity.

The coefficients may differ for each of the first, second, and third error categories. The coefficient for the first error category may be greater than that for the second error category, and the coefficient for the second error category may be greater than that for the third error category. The coefficients may be set such that the evaluation score for the first error category is greater than that for the second error category and the evaluation score for the second error category is greater than that for the third error category. In this manner, the priority of evaluating translation errors in the first error category is higher than that in the second error category. The priority of evaluating translation errors in the second error category is higher than that in the third error category.

The coefficients may vary for each of the severity levels: high, moderate, and low levels. The coefficient for the high level may be greater than that for the moderate level, and the coefficient for the medium level may be greater than that for the low level. The coefficients may be set such that the evaluation score for the high level is greater than that for the moderate level and the evaluation score for the medium level is greater than that for the low level. In this manner, the priority of evaluating translation errors in the high level is higher than that in the moderate level. In this manner, the priority of evaluating translation errors in the moderate level is higher than that in the low level.

### Source Text Translation Process

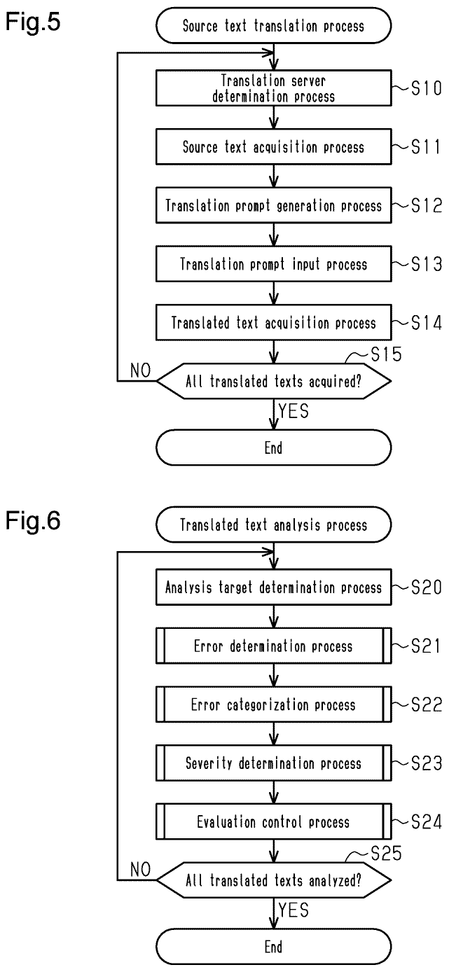

A source text translation process will now be described with reference to FIG. 5. The source text translation process is executed by the processor 20 when a translation instruction for a source text is received. The translation instruction includes a source text identifier, a target language, and a designation of the translation server 12 that serves as a primary translator. The translation instruction may include the language of a source text. The translation instruction includes an instruction to have all specified translation servers 12 perform the translation as the primary translator, translating the source text into the specified language.

As shown in FIG. 5, in step S10, the processor 20 executes the translation server determination process. In this process, the processor 20 determines the translation server 12 that serves as the primary translator from multiple translation servers 12 designated in the translation instruction.

The translation server 12 that serves as the primary translator does not include any translation server 12 that has already served as the primary translation server 12 designated in the translation instruction. The translation server 12 that serves as the primary translator is determined from translation servers 12 that have not yet served as the primary translation server 12 designated in the translation instruction.

For example, of the first translation server 13 and the second translation server 14 designated in a translation instruction, if the first translation server 13 has already served as the primary translator while the second translation server 14 has not yet served as the primary translator, the processor 20 will designate the second translation server 14 as the primary translator. In this manner, the processor 20 sequentially determines the translation servers 12 designated in the translation instruction as the primary translator.

In step S11, the processor 20 executes a source text acquisition process. In this process, the processor 20 reads the source text corresponding to the source text identifier included in the translation instruction from the memory 21. As a result, the processor 20 acquires the source text based on the translation instruction.

In step S12, the processor 20 executes a translation prompt generation process. In this process, the processor 20 generates a translation prompt. The translation prompt includes a source text. The translation prompt may include the language of a source text. The translation prompt includes a target language. The translation prompt includes an instruction of translating a source text into a target language.

In step S13, the processor 20 executes a translation prompt input process. In this process, the processor 20 sends the translation prompt generated in step S12 to the translation server 12 that serves as the primary translator. The translation prompt is input into a translation language model in the translation server 12 that serves as the primary translator. In this manner, the processor 20 inputs the translation prompt into the translation language model of the translation server 12 that serves as the primary translator.

In step S14, the processor 20 executes a translated text acquisition process. In this process, the processor 20 receives the translated text from the translation server 12 that serves as the primary translator. As a result, the processor 20 acquires the translated text. The processor 20 generates a translated text identifier and registers it in the error management database 30 in correspondence with the source text identifier. The processor 20 stores the translated text in the memory 21 in correspondence with the translated text identifier.

In step S15, the processor 20 determines whether all the translated texts have been acquired from each of the translation servers 12 that serve as primary translator. When determining that all the translated texts have not been acquired, the processor 20 proceeds to step S10. When determining that all the translated texts have been acquired, the processor 20 terminates the source text translation process. In this manner, the processor 20 repeatedly executes steps S10 to S14 until it has acquired all the translated texts from every translation server 12 that serves as the primary translator.

Accordingly, the processor 20 acquires the translated text by inputting the source text into the translation language model. Specifically, the processor 20 acquires the first translated text as a translated text by inputting the source text into the first translation language model 13A. The processor 20 acquires the second translated text as a translated text by inputting the source text into the second translation language model 14A.

### Translated Text Analysis Process

The translated text analysis process will now be described with reference to FIGS. 6 to 10. The translated text analysis process is executed by the processor 20 when an analysis instruction is received. The analysis instruction includes a source text identifier and at least one translated text identifier.

In step S20, the processor 20 executes an analysis target determination process. In this process, the processor 20 determines a translated text that is to be analyzed from at least one translated text identifier corresponding to the source text identifier.

The translated text to be analyzed does not contain a translated text corresponding to a translated text identifier that has already been analyzed among translated text identifiers included in the analysis instruction. The translated text to be analyzed is determined from a translated text corresponding to a translated text identifier that has not yet been analyzed among translated text identifiers included in the analysis instruction. For example, of the first translated text and the second translated text included in the analysis instruction, if the first translated text has already been analyzed whereas the second translated text has not yet been analyzed, the processor 20 determines the second translated text as an analysis target.

### Error Determination Process

In step S21, the processor 20 executes an error determination process. In this process, the processor 20 makes a determination related to translation errors in the translated text that has been determined as an analysis target.

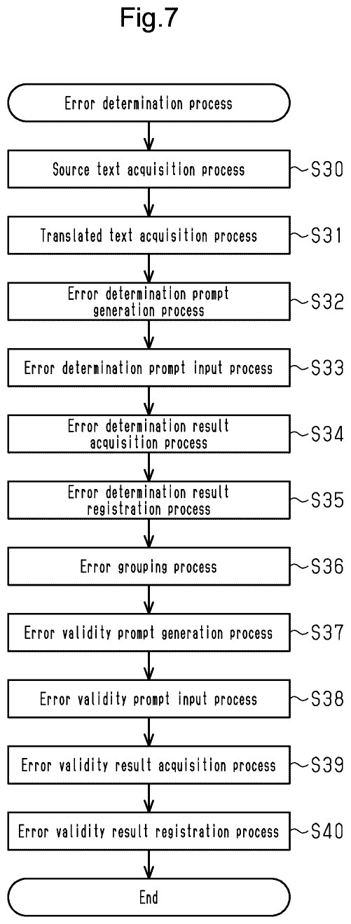

As shown in FIG. 7, the processor 20 executes a source text acquisition process in step S30 of the error determination process. In this process, the processor 20 acquires the source text corresponding to the source text identifier included in the analysis instruction from the memory 21. The processor 20 registers the source text identifier in the error management database 30.

In step S31, the processor 20 executes a translated text acquisition process. In this process, the processor 20 acquires, from the memory 21, the translated text corresponding to the translated text identifier determined as an analysis target. The processor 20 registers the translated text identifier in the error management database 30 in correspondence with the source text identifier.

In step S32, the processor 20 executes an error determination prompt generation process. In this process, the processor 20 generates an error determination prompt. Specifically, the processor 20 generates an error determination prompt that includes the source text obtained in step S30, the translated text obtained in step S31, and an instruction related to the determination of translation errors.

The instruction related to the determination of translation errors include extracting error content, which is at least one error included in the translated text corresponding to the source text. The instruction related to the determination of translation errors includes determining the error category of at least one type of error content. The instruction related to the determination of translation errors includes making a response by associating at least one type of error content with an error category.

In this manner, the error determination prompt includes a source text, a translated text obtained by translating the source text, and an instruction for making a determination by associating a translation error in the translated text with an error category. The error detection prompt corresponds to an example of a first prompt.

The instruction related to the determination of translation errors may include error guideline data used for error category determination. The error guidance data includes data that indicates an error category. The error guidance data may include data that indicates both major categories and subcategories for error category. For example, the error guideline data may include accuracy, fluency, and style as major categories for error category.

In step S33, the processor 20 executes an error determination prompt input process. In this process, the processor 20 sends the error determination prompt generated in step S32 to the LLM 15A. The error determination prompt is input into the LLM 15A on the LLM server 15. In this manner, the processor 20 inputs the error determination prompt into the LLM 15A of the LLM server 15.

In step S34, the processor 20 executes an error determination result acquisition process. In this process, the processor 20 receives the error determination result from the LLM server 15. This allows the processor 20 to acquire the error determination result. That is, the processor 20 acquires the translation error by inputting the error determination prompt into the language model LLM 15A in correspondence with an error category.

In particular, the processor 20 acquires an error determination result that is obtained by associating an error category with at least one type of translation error included in a translated text. The processor 20 may acquire an error determination result that is obtained by associating an error category with multiple types of overlapping error content included in a translated text.

In step S35, the processor 20 executes an error determination result registration process. In this process, the processor 20 registers the error determination result obtained in step S34 in the error management database 30 in correspondence with the source text identifier and translated text identifier.

Specifically, the processor 20 generates an error identifier corresponding to at least one translation error included in a translated text. The processor 20 registers the error content and error category in the error management database 30 in correspondence with the source text identifier, translated text identifier, and error identifier.

In particular, even if multiple types of error overlap each other, the processor 20 registers the error content and error category in the error management database 30 in correspondence with each of the source text identifier, translated text identifier, and error identifier.

In step S36, the processor 20 executes an error grouping process. In this process, the processor 20 groups translation errors when multiple error identifiers correspond to a translated text identifier that has been determined as an analysis target.

When multiple types of error content respectively corresponding to multiple error identifiers overlap each other, the processor 20 updates the error management database 30 such that the same group is associated with the error identifiers in which the multiple types of error content overlaps. In this manner, when acquiring multiple translation errors from a source text, the processor 20 groups overlapping ones of the translation errors.

In step S37, the processor 20 executes an error validity prompt generation process. In this process, the processor 20 generates an error validity prompt. Specifically, the processor 20 generates an error validity prompt that includes the source text obtained in step S30, the translated text obtained in step S31, the error determination result obtained in step S34, and an instruction for determining whether the error determination is valid. The error validity prompt may include an error identifier corresponding to the error determination result.

Particularly, for a group of error determination results that have been grouped into the same group, the processor 20 generates an error validity prompt that includes only one error determination result from the group and does not include the remaining error determination results. That is, the processor 20 generates an error validity prompt that includes a grouped error determination result.

The instruction for determining whether the error determination is valid includes redetermining whether the error determination result indicating that the translated text for the source text contains an error is valid. The instruction for determining whether the error determination is valid includes generating a response indicating whether the error determination result is valid as the redetermination result.

Thus, the error validity prompt includes a source text, a translated text, a translation error, and an instruction for determining whether the translation error is valid. The error validity prompt corresponds to an example of a second prompt.

In step S38, the processor 20 executes an error input prompt generation process. In this process, the processor 20 sends the error validity prompt generated in step S37 to the LLM 15A. The error validity prompt is input into the LLM 15A on the LLM server 15. In this manner, the processor 20 inputs the error validity prompt into the LLM 15A of the LLM server 15.

In step S39, the processor 20 executes an error validity result acquisition process. In this process, the processor 20 receives the error validity result from the LLM server 15. This allows the processor 20 to acquire the error validity result. That is, the processor 20 acquires the information indicating whether the translation error is valid by inputting the error validity prompt into the language model LLM 15A.

In step S40, the processor 20 executes an error validity result registration process. In this process, the processor 20 registers the error validity result obtained in step S39 in the error management database 30 in correspondence with the source text identifier, the translated text identifier, and the error identifier. Particularly, the processor 20 registers the same error validity result in the error management database 30 in correspondence with multiple error identifiers grouped into the same group.

### Error Categorization Process

As shown in FIG. 6, upon completion of the error determination process, the processor 20 executes an error categorization process in step S22. In this process, the processor 20 performs error categorization for translation errors.

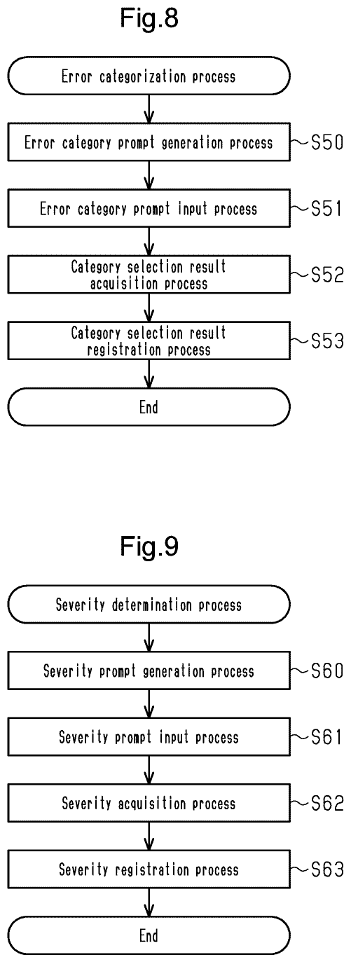

As shown in FIG. 8, in the error categorization process, the processor 20 executes an error categorization prompt generation process in step S50. In this process, the processor 20 generates an error categorization prompt.

Specifically, the processor 20 acquires, from the error management database 30, the error identifier corresponding to the error validity result for which the error determination has been validly performed. The processor 20 generates an error categorization prompt including the error content and error category corresponding to the error identifier and including an instruction for selecting a valid primary category from the error category.

In this case, the processor 20 may acquire, from the error management database 30, the error identifier corresponding to multiple error categories among the error identifiers corresponding to the error validity result indicating that the error determination is valid. The processor 20 does not have to acquire, from the error management database 30, the error identifier corresponding to one error category among the error identifiers corresponding to the error validity result indicating that the error determination is valid. That is, the processor 20 may generate an error categorization prompt when multiple error categories are associated with a translation error.

Particularly, for the error category corresponding to multiple error identifiers grouped into the same group, the processor 20 generates an error categorization prompt that includes multiple error categories corresponding to the grouped error identifiers. That is, the processor 20 generates an error categorization prompt that includes grouped error categories.

In this manner, the error categorization prompt includes a translation error, multiple error categories, and an instruction for selecting a valid primary category from the error categories. The error categorization prompt corresponds to an example of a third prompt.

In step S51, the processor 20 executes an error categorization prompt generation process. In this process, the processor 20 sends the error categorization prompt generated in step S50 to the LLM 15A. The error categorization prompt is input into the LLM 15A on the LLM server 15. In this manner, the processor 20 inputs the error categorization prompt into the LLM 15A of the LLM server 15.

In step S52, the processor 20 executes a category selection result acquisition process. In this process, the processor 20 receives a primary category from the LLM server 15. This allows the processor 20 to acquire the primary category. That is, the processor 20 acquires the primary category corresponding to a translation error by inputting the error categorization prompt into the LLM 15A.

In step S53, the processor 20 executes a category selection result registration process. In this process, the processor 20 registers the acquired primary category in the error management database 30 in correspondence with an error identifier. Particularly, the processor 20 registers the same primary category in the error management database 30 in correspondence with multiple error identifiers grouped into the same group.

### Severity Determination Process

As shown in FIG. 6, upon completion of the error categorization process, the processor 20 executes a severity determination process in step S23. In this process, the processor 20 determines the severity of a translation error.

As shown in FIG. 9, in the severity determination process, the processor 20 executes a severity prompt generation process in step S60. In this process, the processor 20 generates a severity prompt.

Specifically, the processor 20 acquires, from the error management database 30, the error identifier corresponding to the error validity result for which the error determination has been validly performed. The processor 20 generates a severity prompt that includes the error content corresponding to the error identifier, the primary category, and an instruction for determining the severity of the translation error.

In this manner, the severity prompt includes a translation error, a primary category, and an instruction for determining the severity of the translation error. The translation error may include error content. The severity prompt corresponds to an example of a fourth prompt.

The severity prompt may include severity guideline data used to determine the severity of a translation error. The severity guideline data provides criteria for determining the severity of a translation error. For example, the severity guideline data may include criteria of determining that the level of a translation error significantly affecting the user is high. For example, the severity guideline data may include criteria of determining that the level of a translation error that does not significantly affect the user but provides an unintended meaning is moderate. For example, the severity guideline data may include criteria of determining that the level of a translation error that does not significantly affect the user but degrades the fluency or naturalness of the translation is low.

In step S61, the processor 20 executes a severity prompt input process. In this process, the processor 20 sends the severity prompt generated in step S60 to the LLM 15A. The severity prompt is input into the LLM 15A on the LLM server 15. In this manner, the processor 20 inputs the severity prompt into the LLM 15A of the LLM server 15.

In step S62, the processor 20 executes the severity acquisition process. In this process, the processor 20 receives the severity from the LLM server 15. As a result, the processor 20 acquires the severity. That is, the processor 20 acquires the severity of the translation error by inputting the error severity prompt into the language model LLM 15A.

In step S63, the processor 20 executes a severity registration process. In this process, the processor 20 registers the acquired severity in the error management database 30 in correspondence with an error identifier. Particularly, the processor 20 registers the same severity in the error management database 30 in correspondence with multiple error identifiers grouped into the same group.

### Evaluation Control Process

As shown in FIG. 6, upon completion of the severity determination process, the processor 20 executes an evaluation control process in step S24. In this process, the processor 20 evaluates a translated text. That is, the processor 20 evaluates the translation server 12. In other words, the processor 20 evaluates a translation language model.

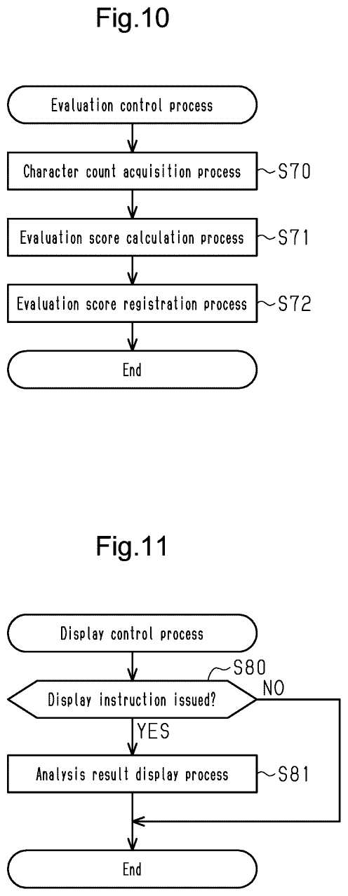

As shown in FIG. 10, in the evaluation control process, the processor 20 executes a character count acquisition process in step S70. In this process, the processor 20 counts the character count of a translated text to be analyzed. In this manner, the processor 20 acquires the character count of the translated text.

In step S71, the processor 20 executes an evaluation score calculation process. In this process, the processor 20 calculates the evaluation score for the translated text to be analyzed. The processor 20 may perform any operation to calculate the evaluation score for the translated text to be analyzed.

Specifically, for each error identifier corresponding to the translated text identifier that is to be analyzed, the processor 20 refers to the error management database 30 to calculate the number of translation errors corresponding to a combination of the primary category and severity.

The processor 20 refers to the coefficient database 31 to read, from the memory 21, the coefficient corresponding to a combination of the primary category and severity. The processor 20 multiplies the number of translation errors by the coefficient for each combination of the primary category and severity.

The processor 20 adds up the multiplication results for each combination of the primary category and severity. The processor 20 calculates the evaluation score by dividing the addition result by the character count of the translated text.

In this manner, the processor 20 calculates the evaluation score for the translated text based on the translation error, primary category, and severity. In particular, the processor 20 calculates an evaluation score for the first translated text and an evaluation score for the second translated text.

Specifically, the processor 20 calculates the evaluation score based on the result of calculating the number of translation errors contained in the translated text and calculating the coefficient corresponding to the primary category and severity. The processor 20 calculates the evaluation score based on the character count of the translated text.

In step S72, the processor 20 executes an evaluation score registration process. In this process, the processor 20 registers the calculated evaluation score in the error management database 30 in correspondence with a translated text identifier.

As shown in FIG. 6, upon completion of the evaluation control process, the processor 20 determines whether all the translated texts to be analyzed have been analyzed in step S25. When determining that all the translated texts to be analyzed have not been analyzed, the processor 20 proceeds to step S20. When determining that all the translated texts to be analyzed have been analyzed, the processor 20 ends the translated text analysis process. In this manner, the processor 20 repeatedly executes steps S20 to S24 until all the translated texts to be analyzed have been analyzed.

### Display Control Process

The display control process will now be described with reference to FIG. 11. The display control process is executed by the processor 20 at predetermined cycles.

In step S80, the processor 20 determines whether a display instruction has been issued. When determining that no display instruction has been issued, the processor 20 terminates the display control process. When determining that a display instruction has been issued, the processor 20 proceeds to step S81.

The display instruction includes a translated text to be displayed, which contains the analysis result. That is, the display instruction includes a designation of a translation server to be displayed. In other words, the display instruction includes a designation of a translation language model to be displayed.

The display instruction includes a display mode for the analysis result. The display mode for the analysis result is a mode of displaying an evaluation score for each translated text to be displayed. The display mode for the analysis result includes a first display mode and a second display mode.

In the first display mode, the number of translation errors corresponding to severity is displayed for each translated text to be displayed. In the second display mode, the number of translation errors corresponding to the primary category is displayed for each translated text to be displayed.

In step S81, the processor 20 executes an analysis result display process. In this process, the processor 20 causes the display device 24 to display an image related to translation errors in correspondence with the display instruction.

Specifically, the processor 20 refers to the error management database 30 that corresponds to the translated text to be displayed, which is included in the display instruction. As a result, the processor 20 acquires data related to the translation errors corresponding to the translated text to be displayed, which is included in the display instruction.

The processor 20 causes the display device 24 to display an image related to the translation errors in correspondence with the display mode for the analysis result included in the display instruction. When the first display mode is included in the display instruction, the processor 20 causes the display device 24 to display, for each translated text to be displayed, an image related to evaluation score and an image related to the number of translation errors corresponding to the severity. When the second display mode is included in the display instruction, the processor 20 causes the display device 24 to display, for each translated text to be displayed, an image related to evaluation score and an image related to the number of translation errors corresponding to the primary category.

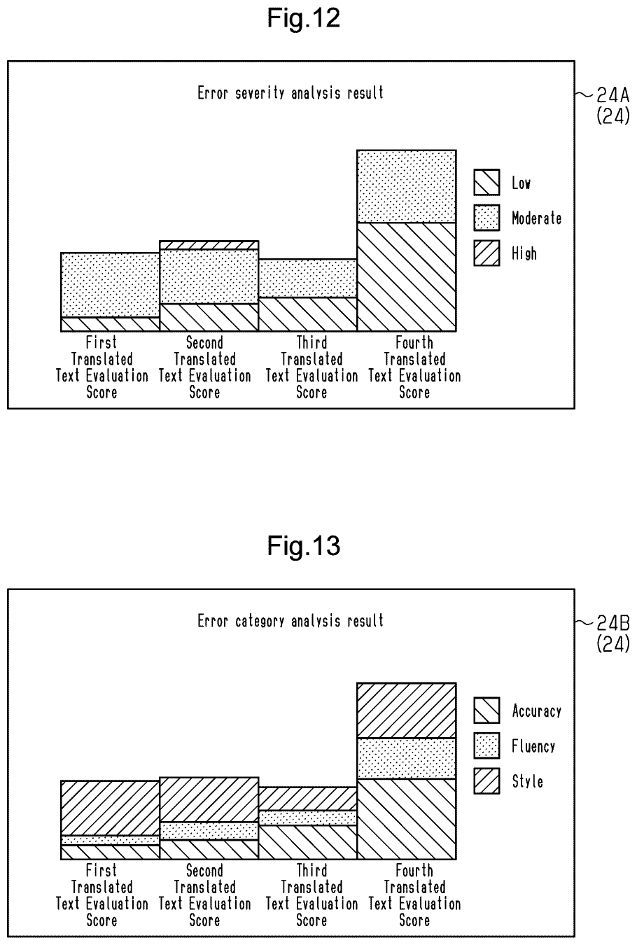

As shown in FIG. 12, when the first display mode is included in the display instruction, the first image 24A is displayed on the display device 24. The first image 24A shows an image indicating an evaluation score for each translated text. The first image 24A shows, for each translated text, an image indicating the number of errors with low severity, the number of errors with moderate severity, and the number of errors with high severity.

As shown in FIG. 13, when the second display mode is included in the display instruction, the second image 24B is displayed on the display device 24. The second image 24B shows an image indicating an evaluation score for each translated text. The second image 24B shows, for each translated text, an image indicating the number of errors in which the primary category is the first error category, the number of errors in which the primary category is the second error category, and the number of errors in which the primary category is the third error category. The first error category may be, for example, accuracy. The second error category may be, for example, fluency. The third error category may be, for example, style.

In this manner, the processor 20 causes the display device 24 to display an image related to translation errors. In particular, the processor 20 causes the display device 24 to display an image related to the evaluation score corresponding to the translated text. The processor 20 causes the display device 24 to display an image related to the translation errors associated with the primary category. The processor 20 causes the display device 24 to display an image related to the translation errors associated with severity.

### Operation and Advantage of Embodiment

The operation and advantages of the embodiment will now be described.

(1) The processor 20 generates an error determination prompt that includes a source text, a translated text, and an instruction for determining a translation error in the translated text in association with an error category. The processor 20 acquires the translation error in correspondence with an error category by inputting the error determination prompt into the language model LLM 15A. This configuration allows the translation error to be acquired from the LLM 15A in correspondence with the error category. This reduces the need for human judgment regarding whether a translation error has occurred and regarding the error categorization of the translation error. Accordingly, manual effort is reduced. As a result, the convenience in evaluating translation accuracy is improved.

In addition, compared to human judgment, the above-described configuration improves the evaluation accuracy for human judgment regarding whether a translation error has occurred and regarding the error categorization of the translation error. As a result, the convenience in evaluating translation accuracy is improved.

(2) The processor 20 generates an error validity prompt that includes a translation error and an instruction for determining whether the translation error is valid. The processor 20 acquires the information indicating whether the translation error is valid by inputting the error validity prompt into the language model LLM 15A. Such a configuration allows the LLM 15A to determine that a translation error has occurred and then determine whether the translation error is valid again. This reduces the need for human judgment regarding whether a translation error has occurred and improves the accuracy of determining whether a translation error has occurred. Accordingly, manual effort is reduced. As a result, the convenience in evaluating translation accuracy is improved.

(3) When acquiring multiple translation errors from a source text, the processor 20 groups overlapping ones of the translation errors. In this configuration, overlapping translation errors are grouped to reduce the load of controlling the overlapping translation errors. As a result, the convenience in evaluating translation accuracy is improved.

(4) When multiple error categories are associated with a translation error, the processor 20 generates an error categorization prompt that includes the translation error, the error categories, and an instruction for selecting a valid primary category from the error categories. The processor 20 acquires a valid primary category corresponding to a translation error by inputting the error categorization prompt into the LLM 15A. In this configuration, even if multiple error categories are associated with a translation error, a valid primary category corresponding to the translation error is acquired from the LLM 15A. This reduces the need for human judgment regarding the valid primary category corresponding to the translation error. Accordingly, manual effort is reduced. As a result, the convenience in evaluating translation accuracy is improved.

(5) The processor 20 generates a severity prompt that includes a translation error, a primary category, and an instruction for determining the severity of the translation error. The processor 20 acquires the severity of the translation error by inputting the error severity prompt into the language model LLM 15A. Such a configuration allows translation error severity to be acquired from the LLM 15A. This reduces the need for human judgment regarding translation error severity. Accordingly, manual effort is reduced. As a result, the convenience in evaluating translation accuracy is improved.

(6) The severity prompt includes a guideline used to determine the severity of a translation error. In this configuration, the guideline for determining the translation error severity is input into the LLM 15A to determine the translation error severity in accordance with the evaluator's intent. As a result, the convenience in evaluating translation accuracy is improved.

(7) The processor 20 calculates the evaluation score for a translated text based on a translation error, primary category, and severity. This configuration allows for an objective evaluation using the evaluation score for the translated text. As a result, the convenience in evaluating translation accuracy is improved.

(8) The processor 20 calculates an evaluation score based on the calculation result of the number of translation errors contained in the translated text and the coefficient corresponding to the primary category and severity. This configuration allows for an objective evaluation using the evaluation score for the translated text, based on the number of translation errors contained in the translated text. Additionally, the use of the coefficient corresponding to the primary category and severity allows evaluation scores for the translated text to be weighted. As a result, the convenience in evaluating translation accuracy is improved.

(9) The processor 20 calculates the evaluation score based on the character count of the translated text. This configuration allows the evaluation score for the translated text to be calculated in consideration of the character count of the translated text. As a result, the convenience in evaluating translation accuracy is improved.

(10) The processor 20 acquires the first translated text by inputting a source text into the first translation language model 13A. The processor 20 acquires the second translated text by inputting the source text into the second translation language model 14A. The processor 20 calculates the evaluation score for the first translated text and the evaluation score for the second translated text. This configuration allows the first translated text and the second translated text to be acquired by inputting the same source text into the first translation language model 13A and the second translation language model 14A. Additionally, the configuration allows for an objective evaluation by comparing the evaluation score for the first translated text with the evaluation score for the second translated text. As a result, the convenience in evaluating translation accuracy is improved.

(11) The processor 20 causes the display device 24 to display an image related to a translation error associated with a primary category. This configuration allows the evaluator to recognize the analysis result of the translation error associated with the primary category. As a result, the convenience in evaluating translation accuracy is improved.

(12) The processor 20 causes the display device 24 to display an image related to a translation error associated with severity. This configuration allows the evaluator to recognize the analysis result of the translation error associated with severity. As a result, the convenience in evaluating translation accuracy is improved.

(13) The processor 20 causes the display device 24 to display an image related to an evaluation score. This configuration allows the evaluator to recognize the analysis result of the evaluation score for a translated text. As a result, the convenience in evaluating translation accuracy is improved.

### Modifications

The present embodiment may be modified as follows. The present embodiment and the following modifications can be combined if the combined modifications remain technically consistent with each other.

The processor 20 may generate a grouping prompt that includes the error content of translation errors and includes an instruction for grouping the translation errors. The processor 20 may acquire the result of the grouped translation errors from the LLM 15A by inputting the grouping prompt into the LLM 15A.

The processor 20 may analyze each of multiple translation errors having overlapping error content without grouping the translation errors. The processor 20 may evaluate each of the translation errors having overlapping error content without grouping the translation errors.

The processor 20 does not have to redetermine whether a translation error is valid after determining that the translation error has occurred from the translated text. The processor 20 may determine the severity of a translation error based on the result of determining that the translation error has occurred from the translated text. The processor 20 may calculate an evaluation score based on the result of determining that the translation error has occurred from the translated text.

The processor 20 does not have to execute step S22 in FIG. 6 when one type of error category corresponds to an error identifier. That is, when multiple error categories correspond to an error identifier, the processor 20 only needs to generate an error categorization prompt and input it into the LLM 15A to acquire the primary category corresponding to the translation error.

The processor 20 does not have to execute step S22 in FIG. 6 even when multiples types of error category correspond to an error identifier. In this case, the processor 20 may analyze the translated text based on at least one error category corresponding to the error identifier, rather than the primary category. For example, the processor 20 may determine the severity of a translation error based on at least one error category corresponding to the error identifier, rather than the primary category. For example, the processor 20 may calculate the evaluation score for a translation error based on at least one error category corresponding to the error identifier, rather than the primary category. When multiple error categories correspond to a single error identifier, the processor 20 may calculate the evaluation score for a translation error for each of the error categories and calculate the average of these evaluation scores as the evaluation score corresponding to the single error identifier. For example, the processor 20 may cause the display device 24 to display the result of analyzing a translation error based on at least one error category corresponding to the error identifier, rather than the primary category.

The processor 20 may calculate the evaluation score for a translated text regardless of the primary category. In this case, the processor 20 does not need to obtain the primary category. The processor 20 may calculate the evaluation score for a translated text regardless of translation error severity. In this case, the processor 20 does not need to obtain the severity of a translation error.

The coefficient database 31 may include primary error categories in which the same coefficient is used. The coefficient database 31 may include severities in which the same coefficient is used. The coefficient database 31 may include a coefficient that is based on primary category or severity. The coefficient database 31 may include an element other than primary category or severity. The element may be, for example, the character count of a translated text.

The processor 20 may calculate the evaluation score for a translated text regardless of a coefficient. In this case, the coefficient database 31 does not have to be stored in the memory 21. The processor 20 may calculate the evaluation score for a translated text based on the character count of a source text. The processor 20 may calculate the evaluation score for a translated text regardless of the character count of the translated text.

The processor 20 may compare evaluation scores for multiple translated texts with each other. The processor 20 may cause the display device 24 to display the result of comparing between the evaluation scores for the translated texts. The processor 20 may cause the display device 24 to display the character counts of the translated texts. When comparing the evaluation scores for the translated texts, the processor 20 may upload the translated text with a relatively low evaluation score to a web server (not shown).

The processor 20 may acquire a source text from a web server (not shown). The processor 20 does not have to execute the source text translation process to acquire a translated text from a source text. In such a case, the processor 20 may acquire a translated text from another server.

The processor 20 may divide a single prompt into multiple prompts and input them into the LLM 15A. The processor 20 may integrate multiple prompts into a single prompt and input it to the LLM 15A.

The information processing system 10 does not need to analyze a translated text obtained by translating a source text. The information processing system 10 does not need to analyze a summary of a source text. That is, the information processing system 10 does not need to analyze an edited text, which is obtained by editing a source text.

In such a case, the translation server 12 may be an editing server, the first translation server 13 may be a first editing server, and the second translation server 14 may be a second editing server. The first translation language model 13A may serve as a first editing language model, and the second translation language model 14A may serve as the first editing language model.

The processor 20 may acquire an edited text by inputting, into an editing language model, a prompt that includes a source text, editing guideline data, which is a guideline for editing the source text, and an instruction for editing the source text. The processor 20 may acquire the determination result of editing errors by inputting, into the LLM 15A, a prompt that includes a source text, an edited text, editing guideline data, and an instruction for determining editing errors. In this case, the processor 20 may input, into the LLM 15A, a prompt that includes an instruction for determining an editing error corresponding to an error category, thereby acquiring the determination result of the editing error corresponding to the error category.

The translation server 12 may include the LLM 15A. In this case, the recipient of prompts other than translation prompts from the information processing device 11 is the translation server 12. The processor 20 may input a prompt related to the first translated text into the LLM 15A of the second translation server 14, and input a prompt related to the second translated text into the LLM 15A of the first translation server 13.

The information processing device 11 may include the LLM 15A. In this manner, in the information processing device 11, the processor 20 may input a prompt to the LLM 15A. In such a case, the information processing system 10 does not have to include the LLM server 15.

In the information processing system 10, instead of the LLM 15A, the processor 20 may input a prompt into a small-scale language model, which has a smaller computational load, data volume, and number of model parameters than the LLM 15A,. In other words, in the information processing system 10, the processor 20 may input a prompt into a language model. The language model may be a learning model using deep learning.

The information processing device 11 does not have to include at least one of the input device 23 and the display device 24. The information processing device 11 may be connected to a terminal device (not shown) via the communication interface 22 to enable communication. The terminal device may include at least one of the input device 23 and the display device 24. In this manner, the processor 20 may display various images on the display device 24 of the terminal device via the communication interface 22. The processor 20 may receive various instructions from the input device 23 of the terminal device via the communication interface 22.

The information processing device 11 only needs to include at least one processor 20 and at least one memory 21. The information processing system 10 only needs to include at least one processor 20 and at least one memory 21.

The information processing device 11 may include multiple servers. In this case, multiple servers are connected to enable communication. The functions of the information processing device 11 may be divided among the servers.

The information processing system 10 may include a different server in addition to the translation server 12 and the LLM server 15, as long as the information processing system 10 includes at least the information processing device 11. The information processing system 10 does not have to include at least one of the translation server 12 and the LLM server 15, as long as the information processing system 10 includes at least the information processing device 11.

The expression “at least one of” as used herein means “one or multiple” of desired options. For example, the phrase “at least any” as used herein means only one option if the number of options is two, or both of the two options. As another example, the expression “at least any” used herein means only one option or a combination of any two or more options if the number of options is three or more.

Technical concepts that can be understood from each of the above-described embodiment and modifications will now be described.

### [Clause 1]

An information processing device, including:
at least one memory configured to store a program; and
at least one processor configured to run the program to execute a process, where
the at least one processor is configured to execute:
generating a first prompt that includes a source text, an edited text obtained by editing the source text, and an instruction for determining an editing error in the edited text in association with an error category; and
acquiring the editing error in correspondence with the error category by inputting the first prompt into a language model.

### [Clause 2]

The information processing device according to clause 1, where
the at least one processor is further configured to execute:
generating a second prompt that includes the editing error and an instruction for determining whether the editing error is valid; and
acquiring information indicating whether the editing error is valid by inputting the second prompt into the language model.

### [Clause 3]

The information processing device according to clause 1 or 2, where
the at least one processor is further configured to execute grouping, when multiple editing errors from the source text are acquired, overlapping ones of the editing errors.

### [Clause 4]

The information processing device according to any one of clauses 1 to 3, where
the at least one processor is further configured to execute:
generating, when multiple error categories are associated with the editing error, a third prompt that includes the editing error, the error categories, and an instruction for selecting a valid error category from the error categories; and
acquiring a valid error category corresponding to the editing error by inputting the third prompt into the language model.

### [Clause 5]

The information processing device according to any one of clauses 1 to 4, where
the at least one processor is further configured to:
generating a fourth prompt that includes the editing error, the error category, and an instruction for determining severity of the editing error; and
acquiring the severity of the editing error by inputting the fourth prompt into the language model.

### [Clause 6]

The information processing device according to clause 5, where
the fourth prompt includes a guideline for determining the severity of the editing error.

### [Clause 7]

The information processing device according to clause 5 or 6, where
the at least one processor is further configured to execute calculating an evaluation score for the edited text based on the editing error, the error category, and the severity.

### [Clause 8]

The information processing device according to clause 7, where
the calculating the evaluation score includes calculating the evaluation score based on a result of calculating the number of editing errors in the edited text and calculating a coefficient corresponding to the error category and the severity.

### [Clause 9]

The information processing device according to clause 8, where
the at least one processor is further configured to execute calculating the evaluation score based on a character count of the edited text.

### [Clause 10]

The information processing device according to any one of clauses 7 to 9, where
the at least one processor is further configured to execute:
acquiring a first translated text as the edited text by inputting the source text into a first machine translation model; and
acquiring a second translated text as the edited text by inputting the source text into a second machine translation model, where
the calculating the evaluation score includes calculating an evaluation score for the first translated text and an evaluation score for the second translated text.

### [Clause 11]

The information processing device according to any one of clauses 1 to 10, where
the at least one processor is further configured to execute display, on a display device, an image related to the editing error associated with the error category.

### [Clause 12]

The information processing device according to any one of clauses 5 to 10, where
the at least one processor is further configured to execute display, on a display device, an image related to the editing error associated with the severity.

### [Clause 13]

The information processing device according to any one of clauses 7 to 10, where
the at least one processor is further configured to execute display, on a display device, an image related to the evaluation score.

### [Clause 14]

The information processing device according to any one of clauses 1 to 13, where
the edited text is a translated text obtained by translating the source text.

### [Clause 15]

An information processing system, including:
at least one memory configured to store a program; and
at least one processor configured to run the program to execute a process, where
the at least one processor is configured to execute:
generating a first prompt that includes a source text, an edited text obtained by editing the source text, and an instruction for determining an editing error in the edited text in association with an error category; and
acquiring the editing error in correspondence with the error category by inputting the first prompt into a language model.

### [Clause 16]

An information processing method, including:
generating, by at least one processor, a first prompt that includes a source text, an edited text obtained by editing the source text, and an instruction for determining an editing error in the edited text in association with an error category; and
acquiring, by the at least one processor, the editing error in correspondence with the error category by inputting the first prompt into a language model.

### [Clause 17]

A program for causing at least one processor to execute:
generating, by at least one processor, a first prompt that includes a source text, an edited text obtained by editing the source text, and an instruction for determining an editing error in the edited text in association with an error category; and
acquiring, by the at least one processor, the editing error in correspondence with the error category by inputting the first prompt into a language model.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing system, comprising:
one or more memories configured to store program code; and
one or more processors, wherein
the one or more processors are configured to read the program code and operate as instructed by the program code, the program code comprising:
first prompt generation code configured to cause at least one of the one or more processors to generate a first prompt that includes a source text, an edited text obtained by editing the source text, and an instruction for determining an editing error in the edited text in association with an error category; and
error acquisition code configured to cause at least one of the one or more processors to acquire the editing error in correspondence with the error category by inputting the first prompt into a language model.

2. The information processing system according to claim 1, wherein
the program code further comprises:
second prompt generation code configured to cause at least one of the one or more processors to generate a second prompt that includes the editing error and an instruction for determining whether the editing error is valid; and
validity code configured to cause at least one of the one or more processors to acquire information indicating whether the editing error is valid by inputting the second prompt into the language model.

3. The information processing system according to claim 1, wherein
the program code further comprises grouping code configured to cause at least one of the one or more processors to group, when multiple editing errors from the source text are acquired, overlapping ones of the editing errors.

4. The information processing system according to claim 1, wherein
the program code further comprises:
third prompt generation code configured to cause at least one of the one or more processors to generate, when multiple error categories are associated with the editing error, a third prompt that includes the editing error, the error categories, and an instruction for selecting a valid error category from the error categories; and
category acquisition code configured to cause at least one of the one or more processors to acquire a valid error category corresponding to the editing error by inputting the third prompt into the language model.

5. The information processing system according to claim 1, wherein
the program code further comprises:
fourth prompt generation code configured to cause at least one of the one or more processors to generate a fourth prompt that includes the editing error, the error category, and an instruction for determining severity of the editing error; and
severity acquisition code configured to cause at least one of the one or more processors to acquire the severity of the editing error by inputting the fourth prompt into the language model.

6. The information processing system according to claim 5, wherein
the fourth prompt includes a guideline for determining the severity of the editing error.

7. The information processing system according to claim 5, wherein
the program code further comprises evaluation score calculation code configured to cause at least one of the one or more processors to calculate an evaluation score for the edited text based on the editing error, the error category, and the severity.

8. The information processing system according to claim 5, wherein
the program code further comprises evaluation score calculation code configured to cause at least one of the one or more processors to calculate an evaluation score for the edited text based on a result of multiplying the number of editing errors in the edited text by a coefficient corresponding to the error category and the severity.

9. The information processing system according to claim 8, wherein
the evaluation score calculation code configured to cause at least one of the one or more processors to calculate the evaluation score for the edited text by multiplying the number of editing errors by the coefficient for each of multiple combinations of the error category and the severity, adding up the multiplication results for each of the combinations, and dividing the addition result by a character count of the edited text.

10. The information processing system according to claim 5, wherein
the program code further comprises:
first translated text acquisition code configured to cause at least one of the one or more processors to acquire a first translated text as the edited text by inputting the source text into a first machine translation model;
second translated text acquisition code configured to cause at least one of the one or more processors to acquire a second translated text as the edited text by inputting the source text into a second machine translation model, and
evaluation score calculation code configured to cause at least one of the one or more processors to calculate an evaluation score for the first translated text and an evaluation score for the second translated text.

11. The information processing system according to claim 1, wherein
the program code further comprises error category display code configured to cause at least one of the one or more processors to display, on a display device, an image related to the editing error associated with the error category.

12. The information processing system according to claim 5, wherein
the program code further comprises error severity display code configured to cause at least one of the one or more processors to display, on a display device, an image related to the editing error associated with the severity.

13. The information processing system according to claim 7, wherein
the program code further comprises evaluation score display code configured to cause at least one of the one or more processors to display, on a display device, an image related to the evaluation score.

14. The information processing system according to claim 1, wherein
the edited text is a translated text obtained by translating the source text.

15. An information processing method, comprising:
causing one or more processors to generate a first prompt that includes a source text, an edited text obtained by editing the source text, and an instruction for determining an editing error in the edited text in association with an error category; and
causing the one or more processors to acquire the editing error in correspondence with the error category by inputting the first prompt into a language model.

16. A non-transitory computer-readable medium that stores program code, the program code comprising:
first prompt generation code configured to cause one or more processors to generate a first prompt that includes a source text, an edited text obtained by editing the source text, and an instruction for determining an editing error in the edited text in association with an error category; and
error acquisition code configured to cause the one or more processors to acquire the editing error in correspondence with the error category by inputting the first prompt into a language model.
